(19) United States
(12) Patent Application Publication
(10) Pub. No.: US 2006/0237870 A1
(43) Pub. Date: Oct. 26, 2006

(54) Method for over-moulding a glazing, sealing joints and a mould for carrying out said method

(75) Inventors: Frédéric Bordeaux, Compiegne (FR); Romain Debailleul, Margny Les Compiegne (FR); Elodie Ducourthial, Compiegne (FR); Guy Leclercq, Cambronne Les Ribecourt (FR)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Saint-Gobain Glass France, Courbevoie (FR)

(21) Appl. No.: 10/560,043

(22) PCT Filed: Jun. 9, 2004
(86) PCT No.: PCT/FR04/01430

§ 371 Date: May 24, 2006

(30) Foreign Application Priority Data
Jun. 10, 2003 (FR) 03/06958

(51) Int. Cl. B27N 3/08

(52) U.S. Cl. 264/239

(57) ABSTRACT

The invention relates to a process for overmolding windows (1), especially curved windows for motor vehicles, by injecting a plastic or reactive material, onto at least part of the surface, especially the peripheral surface, of the window, in which a window is placed in a mold comprising at least one seal (6) defining an overmolding boundary, said seal (6) being a profiled strip inserted into a groove (8) in the mold (3) and held in place by frictional contact and/or by engagement of complementary shapes and/or adhesively bonded to at least one wall (12) of the groove (8), and having a Young's modulus of around 30 to 400 MPa. The invention also relates to a seal having these properties and to a mold fitted with the seal.

The present invention relates to the technique of overmolding a plastic onto an article, such as a window, especially for a motor vehicle.

This technique is generally applied for making up multifunctional assemblies that are incorporated into vehicle bodies. One or more functional elements are added by overmolding, at least onto part of the periphery of the windows, such as a peripheral seal or a frame element that may, where appropriate, have integrated functional elements as inserts to the molded material, or a suitable profile for cooperating with other added functional elements.

Thus, windshields equipped with flush seals, which can be fitted flush with the body, are known, improving the vehicle's coefficient of penetration through the air. Also known are tailgates overmolded onto a rear window or door pillars overmolded onto a side window.

Toughened glass, often required in automobile construction for its contribution to vehicle safety, lends itself particularly well to this technique, but it is also desirable to be able to apply this technique to ordinary or laminated glass panes.

In general, any object can be overmolded by injecting plastic onto at least part of its periphery after this object has been pressed between the two platens of a mold by suitable clamping means, optionally creating a vacuum in a central region in order to ensure that the object is held in place, the overmolded part being bounded by rigid bosses or a series of metal blocks provided in the structure of the mold. Conventional injection molding processes employ high injection pressures, so that the object to be overmolded has to have a high mechanical strength.

Experience has thus shown that the use of this technique, although satisfactory for products having suitable mechanical properties, poses a number of problems when it is applied to products that are particularly fragile, such as glass.

The molds intended for overmolding glass articles therefore generally include resilient seals that act as clamping elements, so as to avoid any direct contact between the glass and the metal of the mold, and which form at least part (a wall or an edge) of the molding cavity.

Devices having such a structure are described for example in U.S. Pat. Nos. 4,561,625, 4,755,339 and 4,761,916.

The constituent material of the clamping element that is in contact, on one side, with the glass and, on the other side, with the injection molding material must be compatible with said material, and especially must not adhere thereto; furthermore, it must exhibit good hot mechanical strength properties in order to withstand the injection temperature of the injected material.

Moreover, although it is excluded to employ a clamping element that would induce unacceptable stresses, resulting in the window breaking (in particular in the case of curved glass windows that inevitably have differences in curvature from one window to another within the same series), it is not recommended however to employ one that is too soft. This is because it is necessary to avoid, during injection of the plastic, and because of the injection pressure, projections beyond the region that was set. This also explains why conventional seals are still insufficient for achieving the desired result: they are relatively soft, in order to fulfill their sealing function and consequently are neither able to clamp the window sufficiently strongly, in order to prevent it from moving, nor to withstand the pressure of the injected material.

European Patent Application EP-127 546 proposes a process for overmolding windows by injecting a plastic under pressure, which uses a seal serving to define the overmolding boundary, this seal exhibiting resilience in a direction approximately perpendicular to the surface of the window in order to absorb the variations in shape or curvature of the window, while still having sufficient rigidity to withstand the injection pressure.

According to that document, the seal has a Shore A hardness of between 65 and 95 approximately, within which range a good compromise is obtained, satisfying the contradictory requirements of flexibility and mechanical strength. A seal made of a polyurethane elastomer exhibiting a good mechanical strength up to temperatures of around 230 to 290° C. is preferred.

U.S. Pat. No. 5,916,600 also recommends a polyurethane seal having a Shore A hardness of 95 in most of the applications in which the dimensional variations of the glass sheets are within normal ranges of values. However, for glass sheets having larger degrees of dimensional variations, a silicone rubber having a Shore A hardness of 80 is recommended: silicone rubber provides a more flexible seal, which better accommodates the dimensional variations of the glass. For applications in which the glass sheet shows less variation, i.e. configurations with less pronounced curvature, a polyethylene terephthalate seal may be used, which is less flexible than polyurethane seals.

As a general rule, the flexible seals recommended for accommodating the series of windows with pronounced dimensional variations allow themselves to be deformed by the glass so that the cross section of the molding cavity differs from one window to another. This is a major drawback when importance is attached to the functional dimensions of the overmolded element.

As the case may be, with overly flexible materials that accommodate the dimensions of the glass, flash may furthermore form by penetration of material between the seal and the surface against which it bears, due to a lack of sealing of the flexible seal under the injection pressure.

U.S. Pat. No. 4,688,752 describes a mold equipped with seals clamped in the upper and lower half-molds by screw systems, the body of the lower seal being preferably harder (with a Shore A hardness of 70) than that of the upper seal (with a Shore A hardness of 50 to 60). These seals, the body of which may be made of nitrile rubber or EPDM, advantageously have, on the side facing the molding cavity, an insert made of a PTFE-type material with a Shore A hardness of 90±5, which, according to the authors, improves the lifetime of the seal but does not prevent the formation of flash and only allows the flash to be removed more easily from the surfaces of the mold.

European Patent Application EP-354 481 also describes a mold equipped with active clamping or return means for pressing the seals against a surface of the mold. The elastomer seals, made of natural or synthetic rubber or made of synthetic elastomer resins, preferably consist of a material having a Young's modulus of 10 to 500 kg/cm² in order to prevent the glass from breaking and to provide the sealing effect.

With this system, the mold clamping force is insufficient to ensure sealing over the entire extent of the molding cavity, and additional pressing means are used to adjust the compression of the seal at any point on the mold in order to achieve sealing. This adjustment requires the modulus and the direction of the compressive force applied to be controlled. These means for controlling the compression of the seal seam to be indispensable when the Young's modulus of the material is not low.

It goes without saying that such mold structures are expensive both from the standpoint of investment and maintenance.

It therefore seems desirable to improve the overmolding techniques so as to achieve better reproducibility of the results, in particular as regards the functional dimensions of the overmolded element.

This need is all the greater in the case of seals inserted into molds, which initially are in the form of a profiled strip and are mounted in the mold by simple insertion into a receiving groove, without a device for checking and adjusting the degree of compression of the seal, as described in U.S. Pat. No. 4,688,752 and EP-354 481.

The object of the present invention is thus to provide an improved overmolding process, which makes it possible to achieve good reproducibility of the results and, preferably, to guarantee that the functional dimensions of the overmolded element are respected, with equipment that is as simple as possible.

In this regard, the subject of the invention is a process for overmolding windows, especially curved windows for motor vehicles, by injecting a plastic or reactive material, onto at least one part of the surface, especially the peripheral surface, of the window, in which:
a window is placed in a mold comprising at least two mold elements that define a molding cavity, at least one seal defining an overmolding boundary,
the mold is closed and the material is injected and
after curing or polymerization, the mold is opened and the overmolded window removed,
   characterized in that said seal is a profiled strip inserted into a groove of the mold element and held against, by frictional contact and/or by engagement of complementary shapes, and/or adhesively bonded to at least one wall of the groove and in that said seal has a Young's modulus of around 30 to 400 MPa (measured according to the ISO 727-1 standard).

Although most of the prior references teach how to choose a material according to its hardness, it is apparent that the rigidity (expressed by the Young's modulus) is an essential parameter as regards correct operation of the seal. Now, two materials of the same hardness may have completely different Young's moduli.

More particularly, a relatively rigid seal has a tendency to withstand a deformation imposed by a body bearing on it: in the case of glass, the inventors have identified a rigidity range in which an inserted seal provides the desired sealing through the action of the mold clamping force whilst still correcting the flatness or curvature defects of the glass sheet, that is to say the seal is not only not deformed but, on the contrary, imposes a deformation on the glass sheet, which approaches the nominal dimensions of the matrix of the mold, doing so without causing the glass sheet to break.

Unexpectedly, the choice of a rigid material furthermore has a considerable influence on the sealing provided by the inserted seal. From the investigations by the inventors, it seems that an advantageous effect is exerted when the inserted seal is fitted into the groove machined in the mold element: during this manual step, the operator inevitably tends to stretch the seal in the longitudinal direction, which causes a local variation in the cross section of the seal. Since the transverse deformations of the seal are larger the lower the Young's modulus (less rigid materials), the variation in cross section is minimized with a high- modulus seal. Thus, a more constant seal cross section along the path of the groove in the mold is obtained. The cross section of the seal in the mold is therefore less sensitive to the variations in fitting by the same operator, or by different operators, thereby guaranteeing the repeatable formation of a fluidtight seal.

A minimum rigidity of around 30 MPa imparts the properties of a seal according to the invention. Advantageously, the Young's modulus is at least 40 MPa, preferably at least 50 MPa, most particularly at least 60 MPa.

Too high a rigidity poses two problems: it leads to the window breaking in a proportion of cases unacceptable for the efficiency of the overmolding operation, and it reduces the conformability of the seal when inserted into the groove, more particularly into a non-straight portion, especially into the rounded edges, resulting in quality defects in the windows that have not broken.

This is why the Young's modulus of the seal is limited to 400 MPa; it is preferably less than or equal to 300 MPa, advantageously around 40 to 200 MPa, for a low in-mold injection pressure (2 to 10 bar), or higher, especially greater than 220-230 MPa, for example 250 MPa, for a high in-mold injection pressure (around 300 bar).

The invention consists in fact in selecting a rigidity range of the seal material within which the curvature defects of the glass are to a large part reduced, but not completely ironed out: standard defects (small differences compared to the theoretical dimensions) are eliminated, whereas the more critical defects (larger differences relative to the theoretical dimensions) are partly erased and converted into standard or less critical defects.

Hereafter, a flatness or curvature defect of the window is defined as being the variation in the height dimension of one point of the window relative to the theoretical dimension (CAD definition of the surfaces) over a given distance in all directions in the plane of the window: there is therefore a slope deviation, expressed in %. As a general rule, a curvature defect of 0.5% is considered as standard and tolerated at the manufacturing stage.

As a nonlimiting illustration, it may be pointed out that, with a seal made of a material having a Young's modulus of 30 to 200 MPa, the curvature defects of the windows that are tolerated at the manufacturing stage (i.e. those having a slope deviation of at most 0.5% relative to the theoretical or nominal dimensions) are essentially ironed out by the seal in the mold, without this causing the window to break. The seal thus gives the window the necessary shape.

A higher rigidity, of around 200 to 400 MPa, which may be desirable for a high injection pressure, generally makes it possible to iron out most of the largest defects (slope deviation of about 1% relative to the theoretical dimensions) without breaking the window.

Another parameter that proves to be advantageous as regard the effectiveness of the seal in the overmolding process according to the invention is the tensile strength of the material. It seems that this parameter, which characterizes (among others) the mechanical resistance of the material, has an influence on the durability of the seal during a manufacturing cycle of the mold.

Thus, a seal with a tensile strength (measured according to the ISO 527-1 standard) of at least 10 MPa may be used for at least twice as long as a conventional seal before overmolding defects appear.

The materials that can be used to form the seal according to the invention may be chosen, according to their mechanical properties mentioned above, from the following families of elastomers: polyolefins, such as polyethylene and polypropylene, especially halogenated polyolefins such as polytetrafluorethylene; vinyl polymers, such as polyvinyl chloride and polyvinylidene fluoride; ethylene/vinyl acetate copolymers; polyamides; ionomer resins; thermoplastic elastomers (TPEs); thermoplastic olefins (TPOs); and polyethersulfone (PES).

The term “thermoplastic elastomers (TPEs)” is understood to mean blends or alloys of a thermoplastic and an elastomer, in which the thermoplastic may especially be a natural or synthetic, hydrocarbon rubber, optionally halogenated, preferably of the ethylene-propylene-diene (EPDM) copolymer type.

The term “thermoplastic olefin (TPO)” is understood to mean assemblies consisting of polyolefins (PP, PE) with unvulcanized elastomers.

Among these materials, TPEs are particularly preferred as they exhibit good chemical resistance to the mold release agents used in certain overmolding processes.

Thus, they retain a sufficient level of their mechanical properties (modulus and tensile strength) even after prolonged exposure to the mold release agents in question.

The shape of the inserted seal is of course matched to each particular overmolding configuration. The cross section of the seal may thus be polygonal or curvilinear, where appropriate with an alternation of concavity, for example with a longitudinal slot on the side facing the bottom of the groove, or, on the contrary, on the side in contact with the window. The seal may be solid, tubular or made of a cellular material (foam).

In one particular embodiment, the seal includes a portion projecting laterally with respect to the body of the seal, said portion being received in a recess adjacent to the groove, which forms a bearing surface for the window. This type of shape is known as a lip seal or scarf seal.

The receiving groove may include, on its vertical walls, projections that engage in the material of the seal, where appropriate in slots of corresponding shape, so as to improve the retention of the seal in the groove.

The process according to the invention applies in particular to the overmolding of a reactive material, such as a reactive injection molding (RIM) polyurethane or a one-component polyurethane, or a thermoplastic such as polyvinyl chloride.

The process according to the invention also applies in particular when the in-mold pressure is around 2 to 400 bar.

It applies advantageously to the overmolding of a plastic element onto a window made of laminated, curved, toughened or hardened glass in which at least one sheet of glass is optionally heat-treated (hardened, annealed, toughened).

Also advantageously, there is no need to provide active clamping or return means for the seal according to the invention, as in the case of the seal disclosed in European Patent Application EP 354 481.

The object of the invention is also a seal as described above that can be inserted into an injection mold, and to an injection mold incorporating such a seal.

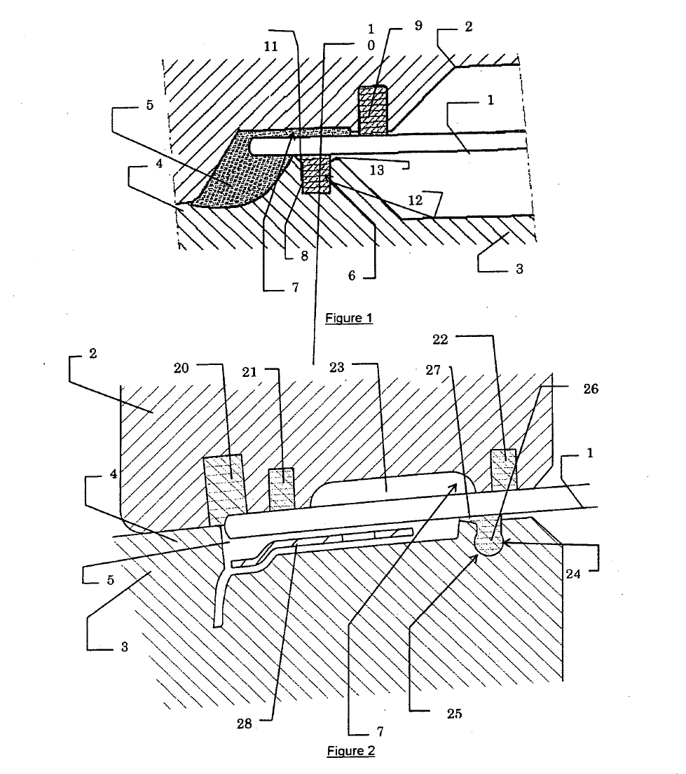

Other features and advantages of the invention will emerge from the detailed description which follows, given in conjunction with the appended drawings in which FIGS. 1 and 2 each represent a partial sectional view of a mold implementing the process according to the invention.

In the device illustrated in FIG. 1, the window 1 is held in place between two metal, especially steel, platens 2 and 3 forming a mold and defining a parting line 4 and a molding cavity 5.

A lower seal 6 intended to limit the injection of the overmolding material, having an edge 7 defining an overmolding boundary of the molding cavity, is placed in a recess in the form of a groove 8 provided for this purpose in the lower platen 3 of the mold. That part of the lower platen 3 of the mold corresponding to the non-overmolded part of the window is not in contact with the window; between the lower face of the latter and the platen of the mold, there is a sufficient space defined by the initial height of the seal 6 and the mold clamping force.

That part of the upper platen 2 of the mold corresponding to the non-overmolded part of the window is itself in contact with the window via another seal—the upper seal 9—preferably of the same nature as the lower seal 6.

The mold has material injection means (not shown) which include at least one injection port and means for supplying the corresponding material. The mold may have additional heating means.

The device is suitable for the injection molding of all kinds of materials allowing different compositions, colors or hardnesses to be injected, depending on the desired properties in the envisioned applications.

These may especially be thermoplastics or thermosets injected in the plastic state, which assume their final shape upon cooling and/or crosslinking, or reactive materials injected in the fluid or viscous state, which polymerize and/or crosslink in the mold.

Thus, for the injection molding it is common practice to use polystyrene, low-density and high-density polyethylene, polypropylene, polyamides, polyvinyl chloride, polyurethane, etc. These base materials may furthermore be reinforced with fibers, especially glass fibers, and/or with other fillers.

Depending on the material injected, it may be preferable to choose a different material for the seal, so as to avoid any risk of the seal adhering to the injected material. Alternatively, the seal may be treated in order to limit this adhesion.

Particularly in the case of PU-RIM encapsulation, it is also desirable to treat the entire molding cavity with a mold release agent which prevents the injected material from adhering to all the adjacent surfaces. The window 1 shown in part may be a flat or curved, especially toughened, monolithic window, but the invention may also apply to composite windows (that combine at least one glass sheet with a sheet of translucent or nontranslucent plastic) or laminated windows (that combine at least one glass sheet with at least one organic or mineral glass sheet via an interlayer) or hardened windows.

The seal 6 is in the form of a profiled strip that can be manufactured by extrusion, by injection molding or by machining, having an approximately parallelepipedal body 10 and a portion 11 projecting laterally with respect to the body of the seal, producing a lip that defines a bearing surface for the window 1, which portion is received in a corresponding surface of the mold, adjacent to the groove 8.

In the embodiment shown, the body 10 of the seal has a width slightly greater than the width of the groove 8, so that the vertical faces of the seal form two surfaces in frictional contact with the vertical walls 12 of the groove.

In a variant (not shown), the seal may be such that the width of the base of the seal in the unfitted state is greater than the width of the groove 8 owing to two excrescences on either side of the base of the seal. The two excrescences form surfaces for frictional contact with the vertical walls 11 of the groove 8, the function of which is to ensure that the fitted seal remains in place.

To make it easier to fit the seal into the groove or, subsequently, to close the mold, it may have a longitudinal slot allowing the necessary deformation when inserting the seal. Alternatively, the seal may have a tubular base or one with a cellular structure, which allows this deformation.

Advantageously, the seal 6 has a height slightly greater than the depth of the groove 8 so that the seal is correctly pressed against the glass when clamping the mold, limiting the stresses generated on the glass which would otherwise be a source of breakage.

This difference in height is preferably sufficient to subject the seal to quite a high stress and to transmit, to the window, a reaction force sufficient to slightly deform the glass should there be a curvature defect. The rigidity of the seal 6 is chosen according to the invention so that the seal reduces the defects in the glass sufficiently, without thereby generating stresses that cause breakage. This height difference may also be calibrated, in order to absorb any variations in thickness of the glass.

As an illustration, the seal 6 may extend beyond the groove 8 by a thickness of around 0.5 to 3 mm, for example in this case 2 mm, in the open mold. When the mold is closed, the seal 6 is free to be compressed (thanks to the presence of unfilled expansion regions such as 13) by about 1 mm so that the window 1 is still prevented from being in contact with the surface of part of the lower mold 3.

When the plastic is injected into the cavity 5, the seal 6 provides a fluidtight contact around the inner edge 7 of said cavity, and prevents any penetration of material into the central part of the window.

This device is used to produce the following examples.

### EXAMPLE 1

When the window 1 was a laminated, curved motor-vehicle windshield, a RIM polyurethane was overmolded. The seal 6 was made of a TPE of the SANTOPRENE brand from Advanced Elastomers Systems, this being based on an EPDM (ethylene-propylene-diene) rubber and on a thermoplastic. It had a Young's modulus of 66 MPa and a tensile strength of 15 MPa.

For this purpose, a wax-based mold release agent (for example from Bomix) was applied to the surfaces of the molding cavity.

A polyol/isocyanate composition was injected into the closed mold at a temperature of 45° C. and at a pressure of 10 bar.

After demolding, the intact windshield was fitted with a peripheral frame, the edges of which correspond perfectly to the theoretical cross section of the mold. No flash was observed, either on the window or on the surfaces of the mold.

The same seal could be used for the manufacture of more than 1000 overmolded articles.

During this manufacturing series, the windows to be treated had initially dimensional deviations relative to the theoretical dimensions ranging up to a 1% slope deviation.

On the one hand, not one breakage was observed and, on the other hand, the overmolded products turned out to have dimensions close to the theoretical dimensions (measurable on the seal cross sections and over the entire periphery of the window), a proof that any defects that there were had been ironed out during the operation and that the window then had the necessary shape.

### COMPARATIVE EXAMPLE 1

This example was produced in the same way, with a seal 6 made of a silicone elastomer, widely used, characterized by a Young's modulus of 6 MPa and a tensile strength of 8 MPa. Within these ranges of moduli, the inventors have not detected any influence of the hardness on the results that follow (Shore A hardness levels of the seal tested between 50 and 90).

The overmolding was carried out without window breakage, with high-quality overmolded profiles being obtained.

However, the dimensional deviations of the window with curvature or thickness defects were not absorbed since they corresponded to deviations of greater than 0.125% relative to the theoretical dimensions, this deviation being much less than the size of a defect currently tolerated (around 0.5%).

Furthermore, the lifetime of the seal was much less since, after fewer than 100 overmolded parts, the overmolded frame no longer had a contour in accordance with the theoretical cross section (defects and flash).

Replacing the seal in the manufacturing process 5 to 10 times more frequently penalizes the rate and the cost of the manufacturing campaign, but also the uniformity of the batch manufactured. This is because each time a new seal is fitted, the surface of the mold does not exactly conform either with the theoretical model or with the surface of the previous series.

This is explained, on the one hand, by the poor initial mechanical properties of the silicone seal, in particular the tensile strength, but also by the degradation due to its exposure to the mold release agents when they are used. Thus, it was confirmed that the silicone saw its Young's modulus and its tensile strength fall dramatically to 3 MPa and 5 MPa respectively, after 1 hour of complete immersion in a mold release agent.

In contrast, the TPE of example 1 suffered a slight loss, with a tensile strength of 13 MPa and a Young's modulus of 55 MPa, after 1 hour of complete immersion in a mold release agent.

### COMPARATIVE EXAMPLE 2

In this example, the seal 6 was made of EPDM, the Young's modulus was 3 MPa and the tensile strength was 9 MPa. Within this range of moduli, the inventors did not detect any influence of the hardness on the results that follow (Shore A hardness levels of the seal tested between 50 and 90).

The observations were similar to those of comparative Example 1, but with insufficient effectiveness in ironing out the defects: only 70% of the minor defects (<0.125% deviation).

The test of resistance to the mold release agent showed that the Young's modulus was maintained, but the tensile strength fell to 6 MPa after 1 hour of complete immersion in the mold release agent.

### EXAMPLE 2

When the same overmolded window manufacturing operation was carried out with an even more rigid seal than in Example 1, with a Young's modulus of 250 MPa, this seal allowed all the defects to be ironed out, even the most critical ones having a deviation of up to 1.4% from the theoretical.

### EXAMPLE 3

In this example, a toughened fixed side window was overmolded with PVC (polyvinyl chloride) of the SUNPRENE KB65 FB brand from Resinoplast (Atofina) at a temperature of 190° C. and under an in-mold pressure of 200 bar.

A seal made of rigid TPE having a Young's modulus of 200 MPa and a tensile strength of around 30 MPa was used.

The choice of these mechanical properties guaranteed retention of sealing at the high injection pressure, preventing the formation of plastic flash outside the molding cavity.

It also allowed the most common dimensional defects of the glass (0.5% deviation from theory) to be ironed out without glass breakage.

The device illustrated in FIG. 2 is a variant in which the upper half-mold is equipped with several seals, all or only some of which may be chosen according to the criteria of the invention. In particular, two conventional seals 21, 22 are provided, these being in contact with upper surface of the window 1 on either side of a vacuum ring 23, the function of which is to keep the window in position on the upper mold part.

In this FIG. 2, the elements identical to those in FIG. 1 bear the same reference as those in FIG. 1.

A seal 20 according to the invention is provided at the parting line 4 between the two half-molds, which has, on the one hand, a sealing function at the parting line, but it also ensures definition of a functional dimension between the surface of the glass and the encapsulation boundary. It has characteristics and a cross section that are appropriate for defining the position of the window relative to the molding cavity. It is this functional dimension that guarantees the subsequent fitting of the window.

A seal 24 intended to limit the injection of the overmolding material at an edge 7 of the molding cavity is fitted into a housing in the form of a groove 25 of partially cylindrical cross section provided for this purpose in the lower platen 3 of the mold.

The seal 24 is composed of a partially cylindrical body 26 with a back-tapered shape and cross section that are suitable for it to be more or less forcibly inserted into the groove 25 (having a cross section slightly smaller than that of the body) and of a lateral projecting portion comprising a lip 27, which defines a bearing surface for the window 1 and is received in a corresponding surface of the mold, adjacent to the groove 25.

The molding cavity is also equipped with means (not shown) for holding an insert element, especially a metal insert element 28, which will be incorporated into the overmolded plastic.

The present invention has been described above by way of example. Of course, a person skilled in the art will be able to produce various alternative embodiments of the invention without thereby departing from the scope of the patent as defined by the claims.

1: A process for overmolding a window, comprising injecting a plastic or reactive material, onto at least one part of a surface, of the window, in which:
a window is placed in a mold comprising at least two mold elements that define a molding cavity, at least one seal defining an overmolding boundary,
the mold is closed and the material is injected and
after curing or polymerization, the mold is opened and the overmolded window removed,
wherein said seal is a profiled strip inserted into a groove of the mold element and held against, by frictional contact and/or by engagement of complementary shapes, and/or adhesively bonded to at least one wall of the groove and in that said seal has a Young's modulus of around 30 to 400 MPa.

2: The process as claimed in claim 1, wherein the seal has a Young's modulus of at least 50 MPa.

3: The process as claimed in claim 1, wherein the seal has a Young's modulus of less than or equal to 300 MPa.

4: The process as claimed in claim 1, wherein the seal has a tensile strength of at least 10 MPa.

5: The process as claimed in claim 1, wherein the seal comprises a material which is at least one elastomer selected from the group consisting of polyolefins, polyethylene, polypropylene, halogenated polyolefins, polytetrafluorethylene, vinyl polymers, polyvinyl chloride, polyvinylidene fluoride, ethylene/vinyl acetate copolymers, polyamides, ionomer resins, thermoplastic elastomers (TPEs), thermoplastic olefins (TPOs), and polyethersulfone (PES).

6: The process as claimed in claim 5, wherein the seal comprises a TPE based on a thermoplastic and on EPDM.

7: The process as claimed in claim 1, wherein the cross section of the seal is polygonal or curvilinear, and optionally with an alternation of concavity.

8: The process as claimed in claim 1, wherein the seal has a longitudinal slot.

9: The process as claimed in claim 1, wherein the seal has a portion projecting laterally with respect to the body of the seal (a lip seal or scarf seal).

10: The process as claimed in claim 1, wherein the injected material is at least one reactive material, selected from the group consisting of a reactive injection molding (RIM) polyurethane, a one-component polyurethane, a thermoplastic and polyvinyl chloride.

11: The process as claimed in claim 1, wherein the in-mold pressure is around 2 to 400 bar.

12: The process as claimed in claim 1, wherein the window comprises laminated, curved, toughened or hardened glass in which at least one sheet of glass is optionally heat-treated.

13: A seal for an overmolding mold, wherein the seal has a Young's modulus of 30 to 400 MPa.

14: The seal as claimed in claim 13, wherein the seal has a Young's modulus of at least 50 MPa.

15: The seal as claimed in claim 13, where the seal has a Young's modulus of less than or equal to 300 MPa.

16: The seal as claimed in claim 13, where the seal has a tensile strength of at least 10 MPa.

17: The seal as claimed in claim 13, wherein the seal comprises a material which is at least one elastomer selected from the group consisting of polyolefins, polyethylene, polypropylene, halogenated polyolefins, polytetrafluorethylene, vinyl polymers, polyvinyl chloride, polyvinylidene fluoride, ethylene/vinyl acetate copolymers, polyamides, ionomer resins, thermoplastic elastomers (TPEs), thermoplastic olefins (TPOs), polyethersulfone (PES) and a TPE based on a thermoplastic and on EPDM.

18: The seal as claimed in claim 13, wherein the seal is manufactured by extrusion, by injection molding or by machining.

19: A mold for the overmolding of windows, comprising at least two mold elements that define a molding cavity and at least one seal defining an overmolding boundary, wherein said seal is a profiled strip inserted into a groove of a mold element and held against, by frictional contact and/or by engagement of complementary shapes, and/or adhesively bonded to at least one wall of the groove and in that said seal has a Young's modulus of around 30 to 400 MPa.

20: The mold as claimed in claim 19, wherein the seal extends beyond the groove over a thickness of 0.5 to 3 mm.

21: The mold as claimed in claim 19, wherein the seal has a Young's modulus of at least 50 MPa.

22: The mold as claimed in claim 19, wherein the seal has a Young's modulus of less than or equal to 300 MPa.

23: The mold as claimed in claim 19, wherein the seal has a tensile strength of at least 10 MPa.

24: The process as claimed in claim 1, wherein the window is a curved window for a motor vehicle.
